(19) United States
(12) Patent Application Publication
(10) Pub. No.: US 2013/0305730 A1
(43) Pub. Date: Nov. 21, 2013

(54) METHOD FOR PREHEATING FUELS IN A GAS TURBINE ENGINE

(71) Applicant: ICR Turbine Engine Corporation, Hampton, NH (US)

(72) Inventors: Frank Wegner Donnelly, North Vancouver (CA); James B. Kesseli, Greenland, NH (US); James S. Nash, North Hampton, NH (US)

(73) Assignee: ICR Turbine Engine Corporation, Hampton, NH (US)

(21) Appl. No.: 13/887,055

(22) Filed: May 3, 2013

Related U.S. Application Data
(60) Provisional application No. 61/643,787, filed on May 7, 2012.
(60) Provisional application No. 61/642,189, filed on May 3, 2012.

(51) Int. Cl. F02C 7/22

(52) U.S. Cl. CPC F02C 7/22
USPC 60/772; 60/730

(57) ABSTRACT

A method and apparatus are disclosed which are directed generally to gas turbine engine systems and specifically to a method utilizing a heat pipe or pipes associated with a thermal oxidizer for preheating a fuel-air mixture. This preheating of a fuel-air mixture allows a substantial reduction in size a thermal oxidizer used as a combustor so that it can be used with all fuels, especially natural gas.

### CROSS REFERENCE TO RELATED APPLICATION

The present application claims the benefits, under 35 U.S.C. §119(e), of U.S. Provisional Application Ser. No. 61/643,787entitled “Thermal Reactor Combustion System for a Gas Turbine Engine” filed May 7, 2012 and U.S. Provisional Application Ser. No. 61/642,189 entitled “Method for Preheating Fuels in a Gas Turbine Engine” filed May 3, 2012 both of which are incorporated herein by reference.

### FIELD

This disclosure relates generally to the field of vehicle propulsion and power generation and, more specifically, to an apparatus and method for pre-heating fuels, especially natural gas, in a thermal oxidizer used as a combustor or reheater in a gas turbine engine.

### BACKGROUND

There is a growing requirement for alternate fuels for vehicle propulsion and power generation. These include fuels such as natural gas, bio-diesel, ethanol, butanol, hydrogen and the like. Means of utilizing fuels needs to be accomplished more efficiently and with substantially lower carbon dioxide emissions and other air pollutants such as NOxs.

The gas turbine or Brayton cycle power plant has demonstrated many attractive features which make it a candidate for advanced vehicular propulsion and power generation. Gas turbine engines have the advantage of being highly fuel flexible and fuel tolerant. Additionally, these engines burn fuel at a lower temperature than reciprocating engines so produce substantially less NOx per mass of fuel burned.

The efficiency of gas turbine engines can be improved and engine size can be further reduced by increasing the pressure and temperature developed in the combustor while still remaining well below the temperature threshold of significant NOx production. This can be done using conventional a metallic combustor or a thermal reactor to extract energy from the fuel. As combustor temperature and pressure are raised, new requirements are generated in other components such as the recuperator and compressor-turbine spools.

One solution is to replace the conventional metallic can type combustor with a thermal reactor also known as a thermal oxidizer. The thermal reactor has a number of advantages including but not limited to reducing combustion temperature and combustion temperature fluctuations with the obvious benefit of further reducing NOx emissions. This in turn allows the combustion temperature to be raised to increase overall thermal efficiency of a gas turbine engine while maintaining emissions such as NOxs at their lowest possible levels.

For use as a combustor or reheater in a gas turbine engine for vehicles, a thermal reactor must be compact. This objective can be accomplished for most fuels but not for natural gas which is potentially the best fuel choice for a fossil fuel in light of its low greenhouse gas emissions relative to other hydrocarbon fuels.

There remains a need for new design approaches for developing a compact thermal reactor to serve as a combustor and/or reheater for vehicle propulsion or power generation where such a combustor can operate on any of several fuels or combinations of fuels at ever increasing combustion temperatures and pressures in gas turbine engines so as to improve overall engine efficiency, reduce engine size while maintaining very low levels of NOx production.

### SUMMARY

These and other needs are addressed by the various embodiments and configurations of the present disclosure which are directed generally to gas turbine engine systems and specifically to a method utilizing heat pipes for reducing the size of a thermal reactor combustor so that it can be used with all fuels, especially natural gas.

In one embodiment, a method is disclosed comprising: 1) receiving, by a gas turbine engine, a fuel mixture of air and a fuel dispersed in the air; 2) contacting the fuel mixture and combustor reaction products with one or more heat pipes, the one or more heat pipes transferring thermal energy from a combustor reaction products to form a heated fuel mixture; and 3) combusting the heated fuel mixture to form the combustor reaction products.

In another embodiment, a gas turbine engine is disclosed comprising: 1) at least first and second turbo-compressor spools, each of the at least first and second turbo-compressor spools comprising a compressor in mechanical communication with a corresponding turbine;

2) a recuperator operable to transfer a second portion of thermal energy of an output gas of a power turbine to a compressed gas produced by the compressor of the at least first and second turbo-compressor spools, thereby providing a heated fuel and air mixture; 3) a combustor operable to combust a further heated fuel and air mixture to form combustor reaction products; and 4) one or more heat pipes transferring a first portion of thermal energy from the combustor reaction products to the heated fuel and air mixture to form the further heated fuel and air mixture.

The benefits of a compact thermal reactor are that it can:
eliminate the need for a gaseous fuel compressor or booster and accessories for gas turbine engines in the case of gaseous fuels such as methane and hydrogen;
extend the selection of fuels to low-specific energy fuels such as swamp gas or land fill gas;
simplify LNG vehicular fuel systems;
result in ultra-low emissions;
can be enclosed in the engine's main recuperator to reduce overall engine volume; and
provide an opportunity for combustor cost reduction.

The present disclosure can provide a method for efficiently reacting lean mixtures of methane and air in a gas turbine engine combustor. The thermal reactor efficiency is dependent upon the reactor bed temperature, the mixture inlet temperature, the stoichiometry, pressure, and residence time. Methane is known to react slowly and requires high temperatures in the absence of a catalyst.

The present disclosure offers a number of practical means of achieving the necessary thermodynamic conditions for a gas turbine thermal reactor which can allow the un-pressurized fuel and air to be introduced at the engine inlet. This strategy of fuel introduction and mixing can eliminate the typical fuel pressurization system and associated parasitic losses, cost and complexity. The present disclosure can incorporate a multi-stage intercooled compressor, a recuperator and a multi-stage turbine to achieve the requisite thermodynamic conditions for a thermal reactor. The high-pressure turbine section can be configured to operate over a small fraction of the overall cycle pressure ratio, thereby resulting in low operating stresses in the high-pressure turbine rotor. This can enable the high-pressure turbine rotor to be manufactured from low-strength, high temperature capability ceramic materials. Materials such as silicon nitride and silicon carbide are suitable for sustained temperatures over 1,370° K provided that the stress levels are maintained below nominally about 220 MPa.

The multi-stage compressor, ceramic high pressure turbine, and recuperator can create a set of conditions conducive to the design of a thermal reactor. A practical thermal reactor for methane/air commonly requires pressure levels over 500 kPa and about a 1,370° K reaction zone temperature to achieve a compact and economical size. An intercooled, recuperated gas turbine with a low stress ceramic high pressure stage is able to operate in these conditions. In the present disclosure, methane and air are introduced the inlet of a gas turbine's compressor. The proportions of fuel are determined by a control system configured to monitor or infer the turbine inlet temperature during operation. The mixture flows through the high-pressure compressor and into an intercooler. The mixture temperatures achieved during this process are commonly below the ignition threshold. The mixture then proceeds through the high pressure compressor, also at low temperatures below the ignition limits. The mixture then enters the recuperator where it is preheated to a temperature closer to the ignition temperature. This temperature is typically controlled to a level where the ignition delay time is sufficiently long to enable the reactants time to reach the thermal reactor. The transport time of the reacting fuel and air is managed by the use of a compact recuperator with short passages and close coupling to the reactor bed combined with other known ways of preheating the mixture before it enters the reactor.

A heat pipe or bundle of heat pipes is used to transport some of the thermal energy of the oxidized gases from downstream of the thermal reactor to the region between the recuperator and combustor and this thermal energy is used to preheat the fuel air mixture by at least about 100° K to about 150° K over its recuperator exit temperature. This additional heat energy is commonly sufficient to raise the fuel air mixture temperature so that, when the fuel is natural gas, the complete reaction of the fuel air mixture can be completed within a compact thermal reactor that is sufficiently small that it may be partially or wholly located within the recuperator.

These and other advantages will be apparent from the disclosures contained herein.

The above-described embodiments and configurations are neither complete nor exhaustive. As will be appreciated, other embodiments of the disclosure are possible utilizing, alone or in combination, one or more of the features set forth above or described in detail below.

The following definitions are used herein:

The phrases at least one, one or more, and and/or are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The Arrhenius equation is a well-known relationship for the temperature dependence of the reaction rate constant, and therefore, rate of a chemical reaction. The reaction rate constant, k, is given by:

k=A exp(−Eₐ/(RT))

where A is a constant, Eₐ is the activation energy, R is the gas constant and T is the absolute temperature.

Combustion as used herein refers to the exothermic conversion of an air-fuel mixture to combustion products by a combustion process that is one of a detonating combustion, a deflagrating combustion and a fast reaction. A fast reaction as used herein means a deflagrating combustion in which the reaction zone extends substantially the entire length of the combustor and the process occurs at a rate much lower than deflagrating combustion.

CNG Means Compressed Natural Gas.

An eductor (also known as an injector, ejector, or thermo-compressor) is a device that uses the Venturi effect of a converging-diverging nozzle to convert the pressure energy of a motive fluid to velocity energy which creates a low pressure zone that draws in and entrains a suction fluid. After passing through the throat of the eductor, the mixed fluid expands and the velocity is reduced which results in recompressing the mixed fluids by converting velocity energy back into pressure energy. The motive fluid as considered herein is a gas. The entrained suction fluid is also a gas.

Energy density as used herein is energy per unit volume (joules per cubic meter).

An energy storage system refers to any apparatus that acquires, stores and distributes mechanical or electrical energy which is produced from another energy source such as a prime energy source, a regenerative braking system, a third rail and a catenary and any external source of electrical energy. Examples are a battery pack, a bank of capacitors, a pumped storage facility, a compressed air storage system, an array of a heat storage blocks, a bank of flywheels or a combination of storage systems.

An engine is a prime mover and refers to any device that uses energy to develop mechanical power, such as motion in some other machine. Examples are diesel engines, gas turbine engines, microturbines, Stirling engines and spark ignition engines

A gasifier is that portion of a gas turbine engine that produce the energy in the form of pressurized hot gasses that can then be expanded across the free power turbine to produce energy.

A gas turbine engine as used herein may also be referred to as a turbine engine or microturbine engine. A microturbine is commonly a sub category under the class of prime movers called gas turbines and is typically a gas turbine with an output power in the approximate range of about a few kilowatts to about 700 kilowatts. A turbine or gas turbine engine is commonly used to describe engines with output power in the range above about 700 kilowatts. As can be appreciated, a gas turbine engine can be a microturbine since the engines may be similar in architecture but differing in output power level. The power level at which a microturbine becomes a turbine engine is arbitrary and the distinction has no meaning as used herein.

A heat pipe is a heat-transfer device that combines the principles of both thermal conductivity and phase transition to efficiently manage the transfer of heat between two solid interfaces. At the hot interface within a heat pipe, a liquid in contact with a thermally conductive solid surface turns into a vapor by absorbing heat from that surface and is transported down the hollow core of the heat pipe to a cold interface. Here, the vapor condenses back into a liquid at the cold interface, releasing the latent heat. The liquid then returns to the hot interface through either capillary action along a wick or gravity action where it evaporates once more and repeats the cycle. The internal pressure of the heat pipe can be set or adjusted to facilitate the phase change depending on the demands of the working conditions of the thermally managed system. A typical heat pipe consists of a sealed pipe or tube made of a material with high thermal conductivity such as copper or aluminum at both hot and cold ends. A vacuum pump is used to remove all air from the empty heat pipe, and then the pipe is filled with a fraction of a percent by volume of working fluid (or coolant) chosen to match the operating temperature. Examples of such fluids include water, ethanol, acetone, sodium, lithium or mercury. Due to the partial vacuum that is near or below the vapor pressure of the fluid, some of the fluid will be in the liquid phase and some will be in the gas phase. The use of a vacuum eliminates the need for the working gas to diffuse through any other gas and so the bulk transfer of the vapor to the cold end of the heat pipe is at the speed of the moving molecules. In this sense, the only practical limit to the rate of heat transfer is the speed with which the gas can be condensed to a liquid at the cold end. Inside the pipe's walls, an optional wick structure exerts a capillary pressure on the liquid phase of the working fluid. This is typically a sintered metal powder or a series of grooves parallel to the pipe axis, but it may be any material capable of exerting capillary pressure on the condensed liquid to wick it back to the heated end. The heat pipe may not need a wick structure if gravity or some other source of acceleration is sufficient to overcome surface tension and cause the condensed liquid to flow back to the heated end.

An ignition characteristic of a fuel refers to a chemical or physical property of the fuel that influences the condition under which the timing and intensity of burning occurs. In reciprocating engines, the timing of fuel ignition is typically desired in a narrow range of the combustion cycle, typically as the peak compression point is approached. Optimum ignition may be determined by performance or emissions requirements or both. For fuels used in reciprocating engines, there are many additives that may be used to modify ignition characteristics. In diesel engines, the cetane number relates to the fuels ease of self-ignition during compression. In spark-ignition engines, the octane rating is a measure of the resistance of the fuel to auto-ignition during compression.

LNG means Liquified Natural Gas. Natural gas becomes a liquid when cooled to a temperature of about 175° K or lower. LNG is predominantly methane, typically 90% or more methane, that has been converted temporarily to liquid form for ease of storage or transport. LNG takes up about 1/600th the volume of natural gas in the gaseous state.

A mechanical-to-electrical energy conversion device refers an apparatus that converts mechanical energy to electrical energy. Examples include but are not limited to a synchronous alternator such as a wound rotor alternator or a permanent magnet machine, an asynchronous alternator such as an induction alternator, a DC generator, a permanent magnet device and a switched reluctance generator.

A prime power source refers to any device that uses energy to develop mechanical or electrical power, such as motion in some other machine. Examples are diesel engines, gas turbine engines, microturbines, Stirling engines, spark ignition engines and fuel cells.

A power control apparatus refers to an electrical apparatus that regulates, modulates or modifies AC or DC electrical power. Examples are an inverter, a chopper circuit, a boost circuit, a buck circuit or a buck/boost circuit.

Power density as used herein is power per unit volume (watts per cubic meter).

A recuperator as used herein is a gas-to-gas heat exchanger dedicated to returning exhaust heat energy from a process back into the pre-combustion process to increase process efficiency. In a gas turbine thermodynamic cycle, heat energy is transferred from the turbine discharge to the combustor inlet gas stream, thereby reducing heating required by fuel to achieve a requisite firing temperature.

Specific energy as used herein is energy per unit mass (joules per kilogram).

Specific power as used herein is power per unit mass (watts per kilogram).

Spool means a group of turbo machinery components on a common shaft.

A thermal energy storage (“TES”) module is a device that includes either a metallic heat storage element or a ceramic heat storage element with embedded electrically conductive wires. A thermal energy storage module is similar to a heat storage block but is typically smaller in size and energy storage capacity.

A thermal oxidizer is a type of combustor (technically a rapid oxidizer that performs the role of a combustor) comprised of a matrix material which is typically a ceramic and a large number of channels which are typically circular in cross section. When a fuel-air mixture is passed through the thermal oxidizer, it begins to react as it flows along the channels until it is fully reacted when it exits the thermal oxidizer. A thermal oxidizer is characterized by a smooth oxidation process as the flow down the channels is effectively one-dimensional fully developed flow with a marked absence of hot spots.

A thermal reactor, as used herein, is another name for a thermal oxidizer.

A turbine is any machine in which mechanical work is extracted from a moving fluid by expanding the fluid from a higher pressure to a lower pressure.

Turbine Inlet Temperature (TIT) as used herein refers to the gas temperature at the outlet of the combustor which is closely connected to the inlet of the high pressure turbine and these are generally taken to be the same temperature.

As used herein, a reference to methane also refers to natural gas, a fuel of which methane is the principal component, unless specifically described otherwise. A reference to natural gas also refers to methane unless specifically described otherwise.

### BRIEF DESCRIPTION OF THE DRAWINGS

The present disclosure may take form in various components and arrangements of components, and in various steps and arrangements of steps. The drawings are only for purposes of illustrating the preferred embodiments and are not to be construed as limiting the disclosure. In the drawings, like reference numerals refer to like or analogous components throughout the several views.

FIG. 1 is a graph of NOx production versus combustion flame temperature.

FIG. 2 is a schematic of a prior art combustor.

FIG. 3 is a schematic of a prior art recuperator

FIGS. 4a-b show a metallic can type combustor and a ceramic thermal oxidizer combustor.

FIG. 5 is prior art schematic of the component architecture of a multi-spool gas turbine engine.

FIG. 6 is a line drawing of a gas turbine suitable for long haul trucks. This is prior art.

FIG. 7 shows a cross-section through a thermal reactor matrix.

FIG. 8 illustrates auto-ignition delay times for methane in a thermal reactor.

FIG. 9 illustrates estimated dimensions of a monolithic thermal reactor.

FIG. 10 illustrates estimated effect of cell density of a monolithic thermal reactor.

FIG. 11a-b illustrate a concept for reducing auto-ignition delay time for methane in a thermal reactor using a heat pipe or pipes.

FIG. 12 further illustrates a concept for reducing auto-ignition delay time for methane in a thermal reactor using a heat pipe or pipes.

FIG. 13 illustrates a compact thermal reactor located outside a recuperator.

FIG. 14 illustrates a compact thermal reactor located partially inside a recuperator in Z-type configuration.

FIG. 15 illustrates a compact thermal reactor located partially inside a recuperator in C-type configuration.

FIG. 16 shows thermal reactor input temperature as a function of thermal reactor output temperature.

FIG. 17 is an isometric schematic view of a prior art heat exchanger.

FIGS. 18a-b show a schematic view of prior art heat exchangers.

FIG. 19 illustrates a wick type heat pipe.

FIG. 20 illustrates a loop type heat pipe system.

### DETAILED DESCRIPTION

The problem as described herein is to devise a compact thermal reactor for use as a combustor in a gas turbine engine for vehicular propulsion. As can be appreciated, such a thermal reactor can also be used in a gas turbine engine for power generation applications, such as for example, back-up power or distributed power. In addition, a thermal reactor can be operated on low BTU fuels. In the case of gaseous fuels such as natural gas, the fuel can be added to the engine's inlet air. This eliminates the need for a separate gas boost compressor for fuel injection at peak engine pressure.

A suitable compact thermal reactor can be designed for fuels such as diesel or propane that have relatively short auto-ignition delay times. However, natural gas of which methane is its principal constituent, is a superior fuel in many applications> However, methane has a relatively long auto-ignition delay time and therefore the size of a suitable thermal reactor for burning natural gas or methane can be unreasonably large for use as a combustor for economical and practical applications.

In a proposed engine design, a metallic can-type combustor is installed inside the recuperator which is a major design benefit for achieving a compact engine configuration. Development of an equally compact thermal reactor that can fit inside a compact, high-effectiveness recuperator and operate on natural gas as one of its fuels is an objective of the present disclosure.

As discussed below, there are several solutions disclosed for developing a compact thermal reactor (also known as a thermal oxidizer) suitable as a combustor for a gas turbine powered vehicle that can operate successfully on methane whether in its purest form or whether as natural gas.

These are:
finding a suitable reactor material that will allow the heat from the downstream reacted gas to conduct upstream in the reactor matrix material so as to effectively preheat the entering un-reacted gas;
embedding conductive wires in the ceramic matrix material that will allow the heat from the downstream reacted gas to conduct upstream in the reactor matrix so as to effectively preheat the entering un-reacted gas;
using a thermal energy storage device to preheat the un-reacted gas;
utilizing a surface catalyst that will accelerate methane reaction time;
seeding the un-reacted gas with a with volatile fuel (such as diesel vapor just prior to introduction into thermal reactor) to accelerate methane reaction time;
operating the reactor at a higher temperature and using the higher temperature combustion products to pre-heat the un-reacted gas using a heat exchanger;
using an eductor system to draw in a portion of combustion products to mix with and pre-heat the un-reacted gas;
operating at a higher TIT or turbine inlet temperature where TIT is the temperature of the combustion products exiting the combustor (thermal reactor);
using a heat pipe to transport heat from the reacted gas downstream of the thermal reactor to upstream of the thermal reactor so as to effectively preheat the entering un-reacted gas;
using enhanced natural gas (adding hydrogen to the natural gas) and
a combination of some or all of the above methods.

In a first attempt to design a compact thermal reactor, the approach was to introduce a fuel-air mixture into the thermal reactor such that the oxidizing reaction would take place as the fuel-air mixture passes down a series of long small diameter tubes fabricated into the reactor body. The mixture would be in intimate contact with the tube walls. It was proposed that, with a suitable material, the heat generated near the end of the thermal reactor would be conducted back upstream through the body of the thermal reactor material and that the amount of conducted heat would be sufficient to pre-heat the un-reacted fuel-air mixture entering the thermal reactor. It was determined through calculations and experiments that this pre-heating effect can be insufficient to pre-heat methane and therefore insufficient to reduce the auto-ignition delay time of methane to a suitably low value for application to a compact thermal reactor for a proposed gas turbine vehicle engine design. It was later determined that, even with a highly thermally conductive reactor material, it may be unlikely to thermally conduct sufficient energy to achieve a high enough pre-heat temperature in an air methane mixture to ensure complete reaction of an air methane mixture in a compact thermal reactor.

For example, to pre-heat an air fuel mixture by about 100° K for a flow of about 1.2 kg/sec, the power required is estimated to be about 132 kW (m Cp dT where m=1.2 kg/s, Cp=1,100 J/kg-K and dT=100° K).

This eliminates the first two solutions in the above list. The next five solutions in the above list are described separately in U.S. Provisional Application Ser. No. 61/643,787entitled “Thermal Reactor Combustion System for a Gas Turbine Engine”.

The following discussion describes a system and method for achieving the necessary level of fuel/air preheat using a heat pipe or pipes to move thermal energy from downstream of a thermal reactor to upstream of the thermal reactor at sufficient power to accomplish the required preheat for an air-methane mixture.

In the present disclosure, the example is used of a gas turbine engine comprising three turbo-machinery spools, an intercooler, a recuperator and a combustor. The three spools are a low pressure turbo-compressor spool, a high pressure turbo-compressor spool and a free power turbine spool.

A typical microturbine engine used for large vehicles is in the output power range of about 250 kW to about 500 kW. These engines operate with high pressure turbine inlet temperatures in the range of about 1,280° K to about 1,370° K and with full power pressure ratios in the range of about 8 to about 15. Peak engine thermal efficiencies for these engines are in the range of about 35% to about 45% (shaft output power to rate of fuel energy consumption based on LHV).

Thermal efficiency can be increased by raising the high pressure turbine inlet temperature and overall engine pressure ratio but this requires material and design upgrades to other components such as, for example, the recuperator, combustor and high pressure turbine assembly.

It is a goal of the present disclosure to increase engine thermal efficiency without significantly increasing NOx emissions. Another objective of the present disclosure is to simplify the engine fuel injection system for methane or natural gas fuels. As stated previously, another objective of the present disclosure is to develop a compact thermal reactor that can fit inside the recuperator and operate on natural gas as one of its fuels. It is noted that the entire thermal reactor need not be completely enclosed by the recuperator. For example, one or both of the ends of the thermal reactor may protrude out of the recuperator. Even if the size of a thermal reactor cannot be made sufficiently compact so as to fit partially or wholly within the recuperator, the goal of a compact thermal reactor is worthwhile as it can still be of a size suitable for vehicle applications and will still deliver the same level of engine efficiency but with substantially lower NOx emissions.

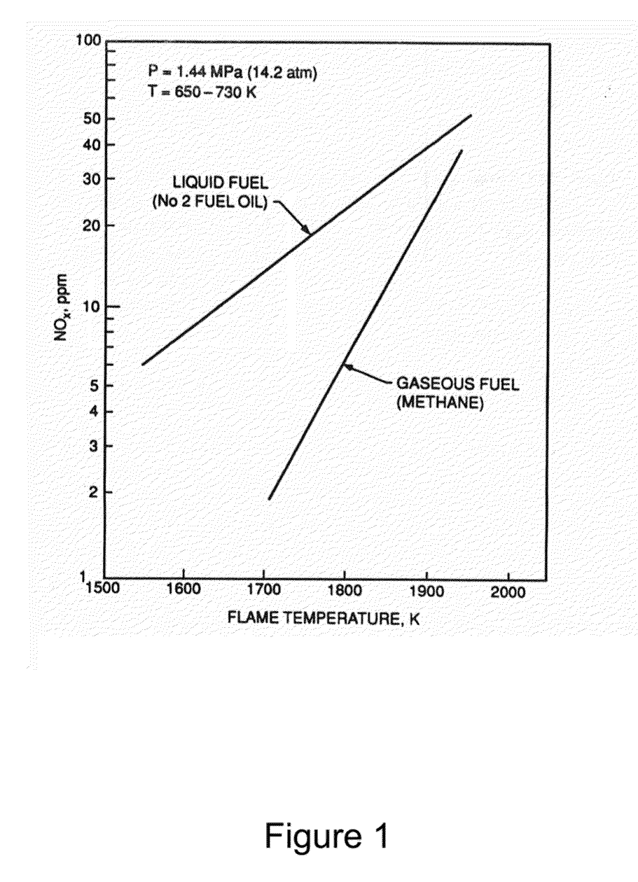

FIG. 1 is a graph of NOx production versus combustion flame temperature. NOx production generally follows the Arrhenius reaction rate law. As can be seen, NOx emissions do not form in significant amounts until flame temperatures reach about 1,800° K. Once this approximate threshold is passed, any further rise in temperature causes a rapid increase in the rate of NOx formation (rapid from the point of view of generating harmful concentrations of NOx that approach or exceed mandated concentrations usually expressed as parts per million (“ppm”) or as grams per kilowatt-hour). NOx production is highest at fuel-to-air combustion ratios of 5 to 7% oxygen (25 to 45% excess air). Lower excess air levels starve the reaction for oxygen and higher excess levels drive down the flame temperature, slowing the rate of reaction.

Current EPA standards for engines in the range of about 100 kW or above is 0.27 g/kW-hr of NOx. Diesels can achieve this NOx emissions standard by a number of strategies but each accrues a cost in terms of power plant weight, power plant efficiency and/or complexity. Gas turbine engines in the range of about 250 kW to about 500 kW and operating at peak combustion temperatures of about 1,700° K produce about 0.05 g/kW-hr of NOx. The 1,700° K is the temperature attained in the combustor reaction chamber where fuel is mixed with about 60% of the inlet air. The other approximately 40% of air is used for cooling and ultimately diluting the combustion products to the desired combustor outlet or turbine inlet temperature of about 1,370° K.

It is clear that, with the use of a thermal reactor, the thermal efficiency of gas turbine engines such as described above can be increased by increasing peak combustor temperature without increasing NOx to levels that would exceed current and near-future EPA standards. This is because the fuel-air mixture remains fully diluted in a thermal reactor and does not have an inner combustion zone where combustion temperatures are higher than the combustor outlet, such as described for the metallic can-type combustors discussed below.

Gas turbine combustor designs are being improved to reduce or eliminate temperature excursions above average combustion temperatures. These excursions above average combustion temperatures will increase NOx production and their elimination will minimize NOx production.

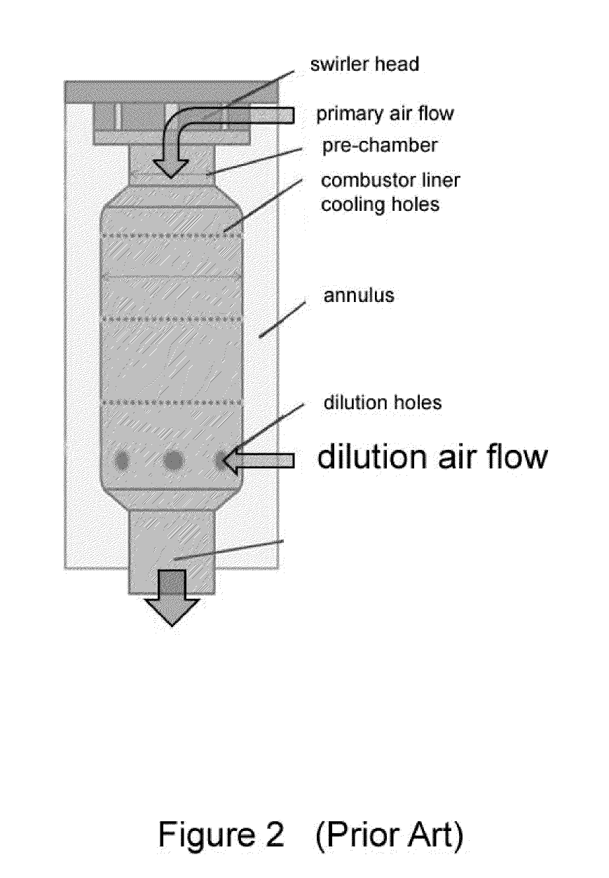

FIG. 2 is a schematic of a prior art combustor. This is an all-metallic combustor known as a can-type combustor. There are also other types of metallic combustors such as annular and cannular combustors. Typically the gas turbine air stream flowing into the combustor is divided into a primary air flow and a dilution air flow. The primary air flow and the fuel are introduced together through a swirler head which is designed to deliver a fully mixed fuel-air mixture of the proper proportions which is formed in the pre-chamber. The swirler head and pre-chamber are designed to produce a gas mixture suitable for homogeneous combustion within the main body of the combustor (between the pre-chamber and the dilution holes). The dilution air flow is typically introduced into the fully combusted gases in the downstream end of the combustor. The fully combusted and diluted gas is then delivered, in the present example engine, to a high pressure turbine. The combustor also includes one or more sets of cooling holes which introduce cooling air into the liner formed by the outside of the combustor and the outside of the combustion chamber which is contained inside the combustor. The goal of this type of combustor design is to produce the most homogeneous combustion possible. That is, to reduce or eliminate temperature excursions above and below the average desired combustion temperature.

Typical conditions in a high-performance metallic combustor sized for an engine of approximately 300 kW to about 500 kW shaft output power are an inlet flow of about 1.2 kg per second of air is mixed with about 21 grams per second of methane fuel. Of the about 1.2 kg/sec of input air, in the range of about 50% to about 70% by mass enters the swirler head and in the range of about 30% to about 50% is diverted for use as dilution air flow. Of the dilution air flow, about 30% to about 50% is used for cooling the combustion housing and liner and the remaining portion of the dilution air flow is directed into the dilution holes. The combustor is typically housed in an annular container which serves as a guide for the dilution air flow.

In this example, the average combustion temperature in the combustor chamber with 60% of the inlet air is about 1,710° K while the fully diluted combustion products are output to the adjacent turbine at about 1,365° K

In this example, the combustion takes place at an approximately constant pressure of about 1,450 kPa. The outlet temperature (also the same as turbine inlet temperature) in this example is approximately 1,366° K. The measured NOx in the output stream is about 5 ppm which is considerably higher than would be estimated from the methane curve of FIG. 1. This is thought to be a result of non-homogeneous combustion in this type of metallic can combustor.

The engine design used herein includes a recuperator which is a heat exchanger that transfers heat from the hot side of the heat exchanger (typically heat from the flow of exhaust gas) to the gas flow on cold side of the heat exchanger (typically gas air or a fuel-air mixture). The heated gas from the cold side is thereby pre-heated just before entering the combustion chamber by the residual energy contained in the exhaust gas.

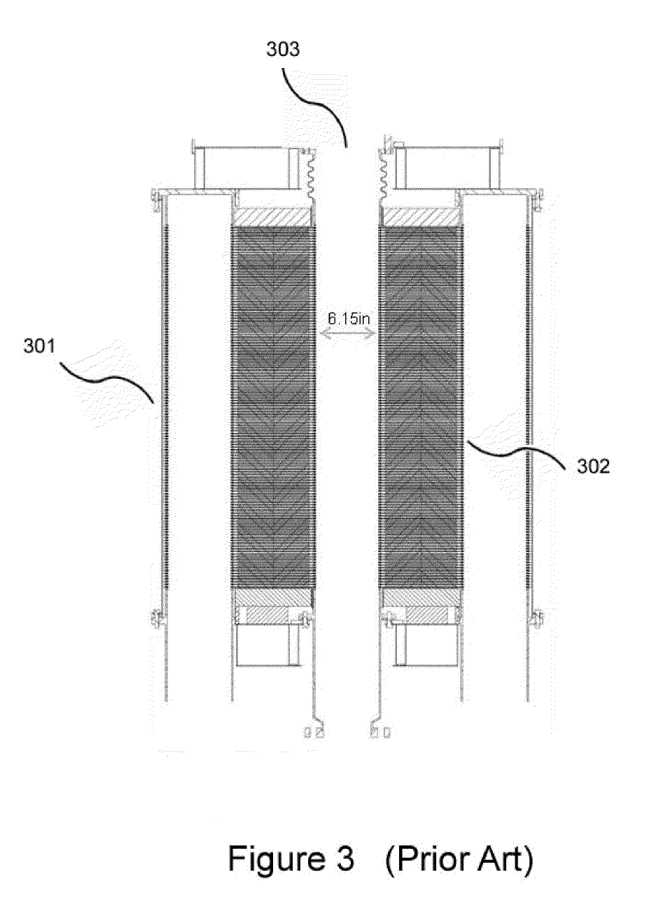

FIG. 3 is a schematic of a prior art recuperator which is designed so that the combustor can be located inside the recuperator, primarily to conserve space in the engine. The technique of embedding the combustor inside a recuperator is not new. However, as combustor temperature and pressure are increased to gain higher efficiencies then innovative means of protecting the recuperator from the radiant heating of the combustor must be found. This problem of radiant heating would not be applicable to a thermal reactor type of combustor.

The recuperator in FIG. 3 is shown in front view and is enclosed by structure 301 which contains the recuperator cold side matrix 302 and the center opening 303 in which the combustor is inserted. As can be seen, the combustor will be in close proximity to the recuperator and therefore protecting the recuperator from the radiated heat from the combustor will be an important design consideration, especially if it is desired to increase the pressure and temperature of the combustion process so as to increase overall engine thermal efficiency. The design shown in FIG. 3 is a three-manifold, dual-matrix counter-flow plate-fin heat exchanger, whose design allows free growth of hot center manifold supported by tensile structures at cold ends. This recuperator design is described in U.S. patent application Ser. No. 12/115,069 filed May 5, 2008, entitled “Heat Exchange Device and Method for Manufacture” and in U.S. patent application Ser. No. 12/115,219 filed May 5, 2008, entitled “Heat Exchanger with Pressure and Thermal Strain Management”, both of which are incorporated herein by reference.

### Other Types of Combustors

Modern gas turbine engines incorporate combustor for reacting pressurized fuel and air to increase turbine inlet temperature. Typically a pressurized fuel source delivers liquid or gaseous fuel to a pre-mixer just upstream of the combustion zone. Alternative designs, as proposed by Dibble (U.S. Pat. No. 6,205,768) and others (Pfefferle U.S. Pat. No. 4,864,811, Mackay U.S. Pat. No. 4,754,607) describe a method whereby gaseous fuel is introduced at the engine's compressor inlet, mixed with air while passing through the compressor and recuperator, and reacted in a catalytic bed upstream of the turbine. The catalyst is a necessary requirement for most gas turbine engines to enable and complete the fuel/air reaction in a reasonable time and volume. However, catalysts are known to be expensive and life limiting in a gas turbine environment. Still other gas turbine combustion inventions by Kesseli (U.S. Pat. No. 6,895,760) introduce volatile organic compounds (VOCs) at the engine's compressor inlet, mix the VOC and air during passage through the engine, then react the mixture on a high temperature matrix, or so-called thermal reactor. The thermal reactor is less expensive than a catalytic bed and has longer life, however this approach works only with high volatility organic compounds, such as propane and heptane.

It is also possible to efficiently react mixtures of fuel and air in a gas turbine engine combustor in a thermal oxidizer reactor. The thermal reactor efficiency is dependant upon the reactor bed temperature, the mixture inlet temperature, the stoichiometry, pressure, and residence time. Methane is known to react slowly and require high temperatures in the absence of a catalyst. This proposed disclosure offers a practical means of achieving the necessary thermodynamic conditions for a gas turbine thermal reactor which allows an un-pressurized gaseous fuel and air to be introduced at the engine inlet. This strategy of fuel introduction and mixing eliminates the typical fuel pressurization system and associated parasitic losses, cost and complexity. Alternately, fuel may be introduced just ahead of the combustor.

A multi-stage compressor, ceramic first stage turbine, and recuperator create a set of conditions conducive to the design of a thermal reactor. A practical thermal reactor for methane/air requires pressure levels over 5 bar and 1,700° K reaction zone temperature to achieve a compact and economical size with a methane and air mixture, which is the most difficult fuel to react in this type of combustor.

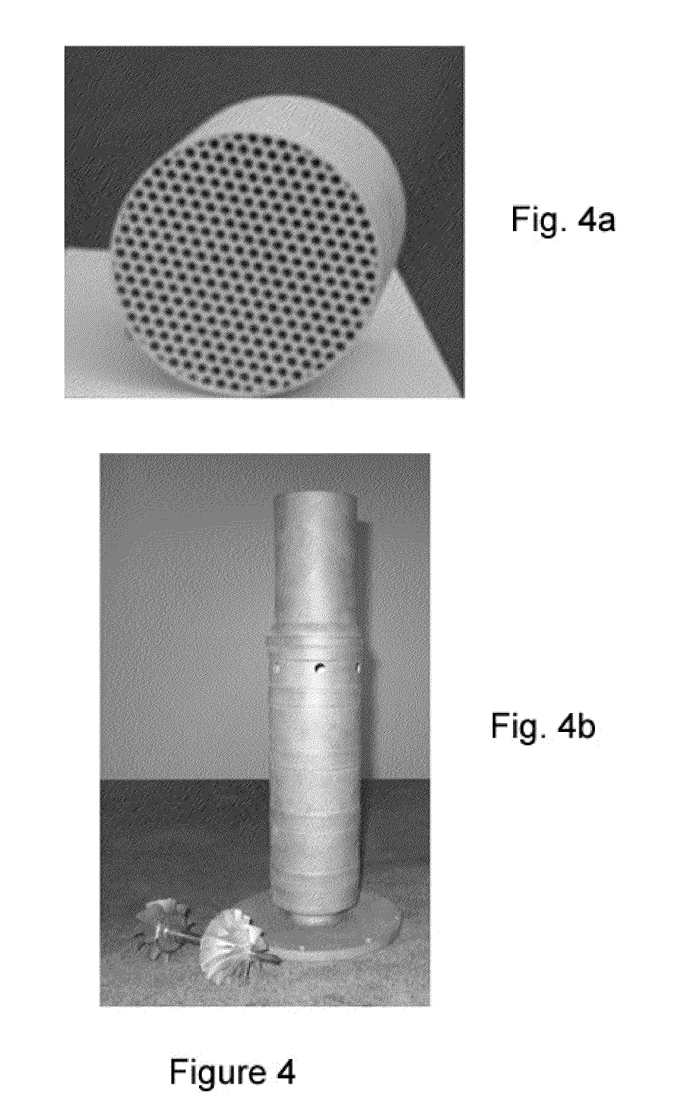

FIG. 4 shows a metallic can type combustor (FIG. 4b) and an experimental ceramic thermal oxidizer combustor (FIG. 4a). The design of the thermal reactor as shown in FIG. 4b is a cylindrical device with a number of small diameter channels that allow a simple flow pattern for the fuel-air mixture. As the reaction of fuel and air proceeds, the temperature of the gas increases. The heating of the channel walls causes heat conduction back towards the inlet end of the combustor. This conducted heat is then added to the inlet mixture—a process that will increase reaction rate of the fuel-air mixture until an equilibrium heat distribution is reached.

As can be appreciated, the catalytic, VOC or thermal oxidizer type of combustor can be substituted for a metallic can-type combustor in the embedded combustor design.

### Exemplary Gas Turbine Engine

A preferable engine type is a high efficiency gas turbine engine because it typically has lower NOx emissions, is more fuel flexible and has lower maintenance costs. For example, an intercooled recuperated gas turbine engine in the 10 kW to 650 kW range is available with thermal efficiencies above 40%. A schematic of an intercooled, recuperated gas turbine engine is shown in FIG. 1.

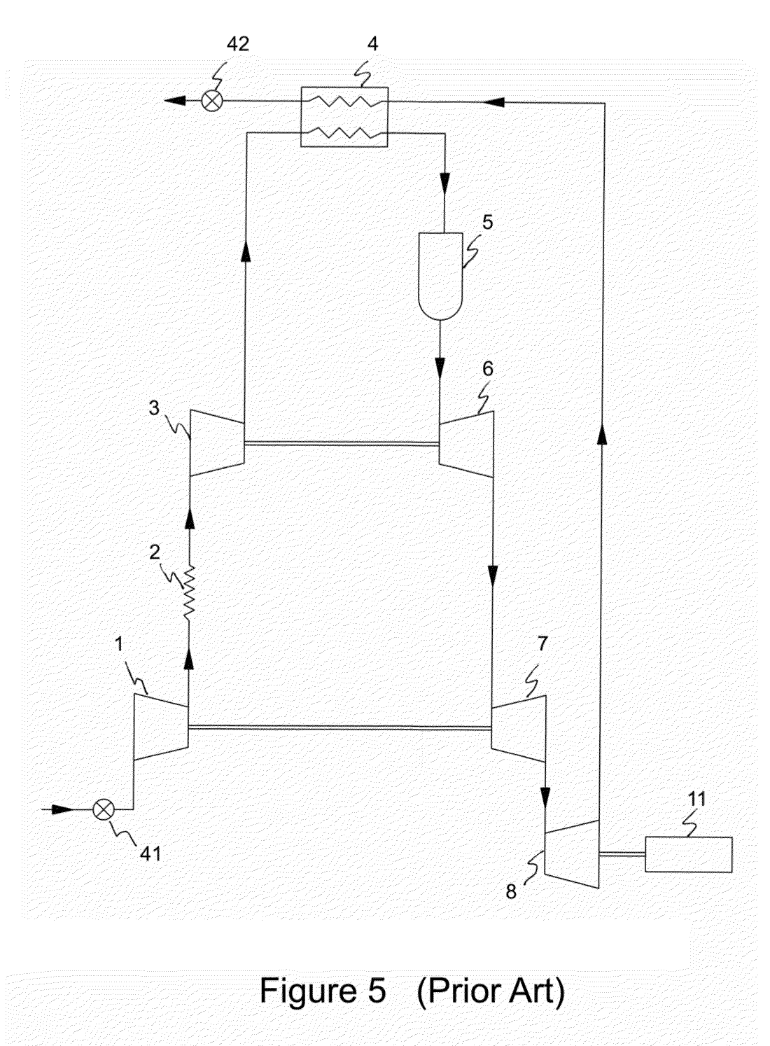

FIG. 5 is prior art schematic of the component architecture of a multi-spool gas turbine engine. Gas is ingested into a low pressure compressor 1. The outlet of the low pressure compressor 1 passes through an intercooler 2 which removes a portion of heat from the gas stream at approximately constant pressure. The gas then enters a high pressure compressor 3. The outlet of high pressure compressor 3 passes through a recuperator 4 where some heat from the exhaust gas is transferred, at approximately constant pressure, to the gas flow from the high pressure compressor 3. The further heated gas from recuperator 4 is then directed to a combustor 5 where a fuel is burned, adding heat energy to the gas flow at approximately constant pressure. The gas emerging from the combustor 5 then enters a high pressure turbine 6 where work is done by the turbine to operate the high pressure compressor 3. The gas from the high pressure turbine 6 then drives a low pressure turbine 7 where work is done by the turbine to operate the low pressure compressor 1. The gas from the low pressure turbine 7 then drives a free power turbine 8. The shaft of the free power turbine, in turn, drives a transmission 11 which may be an electrical, mechanical or hybrid transmission for a vehicle. Alternately, the shaft of the free power turbine can drive an electrical generator or alternator. This engine design is described, for example, in U.S. patent application Ser. No. 12/115,134 filed May 5, 2008, entitled “Multi-Spool Intercooled Recuperated Gas Turbine”, which is incorporated herein by reference.

As can be appreciated, the engine illustrated in FIG. 5 can have additional components (such as for example a re-heater between the high pressure and low pressure turbines) or can have fewer components (such as for example a single compressor-turbine spool, or no free power turbine but shaft power coming off the low pressure turbine spool).

A gas turbine engine is an enabling engine for efficient multi-fuel use and, in particular, this engine can be configured to switch between fuels while the engine is running and the vehicle is in motion (on the fly). In addition, a gas turbine engine can be configured to switch on the fly between liquid and gaseous fuels or operate on combinations of these fuels. This is possible because combustion in a gas turbine engine is continuous (as opposed to episodic such as in a reciprocating piston engine) and the important fuel parameter is the specific energy content of the fuel (that is, energy per unit mass) not its cetane number or octane rating. The cetane number (typically for diesel fuels and compression ignition) or octane rating (typically for gasoline fuels and spark ignition) are important metrics in piston engines for specifying fuel ignition properties.

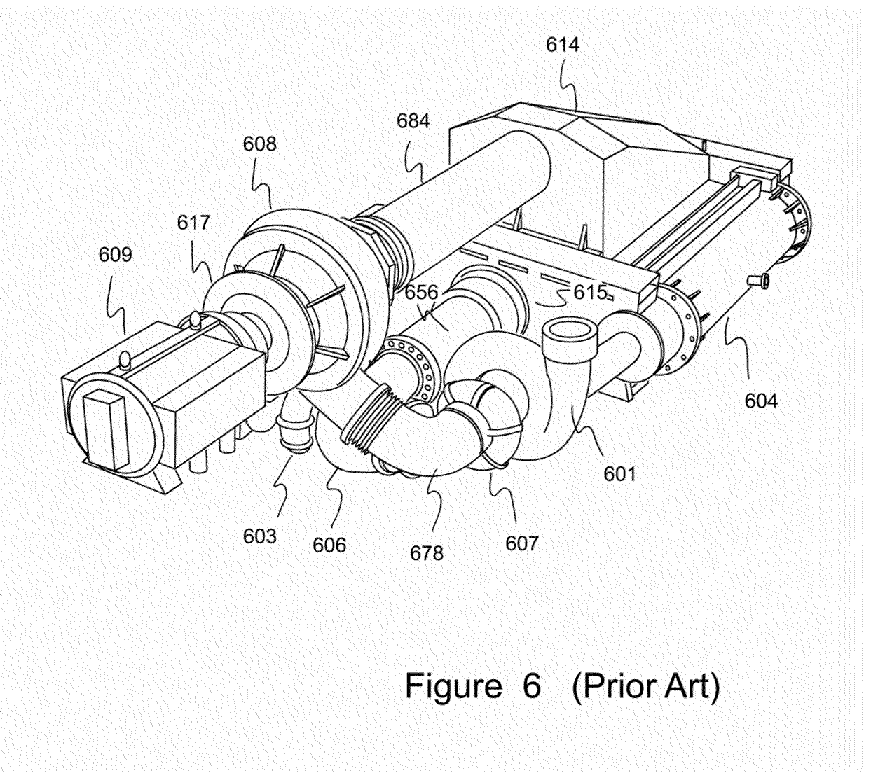

The gas turbine engine such as shown in FIG. 6 enables the fuel strategy of the present disclosure. This engine configuration has been previously disclosed although efficient multi-fuel configurations will require innovative modifications. This is an example of an approximately 375 kW engine that uses intercooling and recuperation to achieve high operating efficiencies (about 40% or more) over a substantial range of vehicle operating speeds. This compact engine is suitable for light to heavy trucks. Variations of this engine design are suitable for smaller vehicles as well as applications such as, for example, marine, rail, agricultural and power-generating. One of the principal features of this engine is its fuel flexibility and fuel tolerance. This engine can operate on any number of liquid fuels (gasoline, diesel, ethanol, methanol, butanol, alcohol, bio diesel and the like) and on any number of gaseous fuels (compressed or liquid natural gas, propane, hydrogen and the like). This engine may also be operated on a combination of fuels such as mixtures of gasoline and diesel or mixtures of diesel and natural gas. Switching between these fuels is generally a matter of switching fuel injection systems and/or fuel mixtures.

For example, at a first time a gas turbine engine burns a first fuel mixture, and at a second time, a different second fuel mixture. The first and second mixtures include at least one uncommon fuel type. The first mixture, for instance, can have diesel as the primary fuel, and the second mixture CNG or LNG as the primary fuel. In another illustration, the first mixture is a first mixture ratio of fuels A and B, and the second mixture a different second mixture ratio of fuels A and B. In all of the above illustrations, the specific energy of the first fuel mixture is commonly at least about 20%, more commonly at least about 50%, and even more commonly at least about 80% of the specific energy of the second fuel mixture. For example, a reciprocating engine typically burns fuels having a low heat value (LHV) in the range of about 40 million to about 55 million Joules per kilogram. A gas turbine engine can burn fuels having a low heat value (LHV) in the range of about 10 million to about 55 million Joules per kilogram.

Not only can a gas turbine burn fuels of lower specific energy, but they can burn less complex fuels as discussed below. This has the potential of reducing the costs of refining fuels by simplifying fuel requirements.

This engine operates on the Brayton cycle and, because combustion is continuous, the peak operating temperatures are substantially lower than comparable sized piston engines operating on either an Otto cycle or Diesel cycle. This lower peak operating temperature results in substantially less NOx emissions generated by the gas turbine engine shown in FIG. 6. This figure shows a load device 609, such as for example a high speed alternator, attached via a reducing gearbox 617 to the output shaft of a free power turbine 608. A cylindrical duct 684 delivers the exhaust from free power turbine 608 to a plenum 614 which channels exhaust through the hot side of recuperator 604. Low pressure compressor 601 receives its inlet air via a duct (not shown) and sends compressed inlet flow to an intercooler (also not shown). The flow from the intercooler is sent to high pressure compressor 603 which is partially visible underneath free power turbine 608. As described previously, the compressed flow from high pressure compressor 603 is sent to the cold side of recuperator 604 and then to a combustor which is contained inside recuperator 604. The flow from combustor 615 (whose outlet end is just visible) is delivered to high pressure turbine 606 via cylindrical duct 656. The flow from high pressure turbine 606 is directed through low pressure turbine 607. The expanded flow from low pressure turbine 607 is then delivered to free power turbine 608 via a cylindrical elbow 678.

This engine has a relatively flat efficiency curve over wide operating range (from about 20% of full power to about 85% of full power. It also has a multi-fuel capability with the ability to change fuels on the fly as described in U.S. Provisional Application No. 61/325,578 entitled “Multi-Fuel Vehicle Strategy” which is incorporated herein by reference.

Start-up of the gas turbine shown in FIGS. 5 and 6 can be a problem since there is initially no heat input from the recuperator. This can be a problem especially for an engine using a thermal reactor for its combustor. It may be advantageous to allow the flow of combustion products to bypass either or both of the low pressure turbine and the free power turbine until sufficient heat transfer through the recuperator is established.

### The Thermal Oxidizer or Thermal Reactor

A thermal oxidizer is a type of combustor (technically a rapid oxidizer that performs the role of a combustor) comprised of a matrix material which is typically a ceramic and a large number of channels which are typically circular in cross section. When a fuel-air mixture is passed through the thermal oxidizer, it begins to react as it flows along the channels until it is fully reacted when it exits the thermal oxidizer. A thermal oxidizer is characterized by a smooth oxidation or reaction process as the flow down the channels is effectively one-dimensional fully developed flow with a marked absence of hot spots. A thermal reactor, as used herein, is another name for a thermal oxidizer.

The following table shows some important properties of ceramics that are typically used for gas turbine components such as rotors, shrouds, volutes and thermal reactors.

TABLE 1

| | | | Silicon | Silicon | |
|---|---|---|---|---|---|
| | Alumina | Cordierite | Carbide | Nitride | Mullite |
| Density | 3,700- | 2,600 | 3,210 | 3,310 | 2,800 |
| (kg/m3) | 3,970 | | | | |
| Specific Heat | 670 | 1,465 | 628 | 712 | 963 |
| (J/kg/C.) | | | | | |
| Thermal Conductivity | 24 | 3 | 41 | 27 | 3.5 |
| (W/m/C.) | | | | | |
| Coefficient Thermal | 8.39 | 1.7 | 5.12 | 3.14 | 5.3 |
| Expansion | | | | | |
| (μm/m/C.) | | | | | |
| Thermal Shock | 200-250 | 500 | 350-500 | 750 | 300 |
| Resistance (ΔT (C.)) | | | | | |
| Maximum Use | 3,650 | 1,370 | 1,400 | 1,500 | 1,700 |
| Temperature (C.) | | | | | |

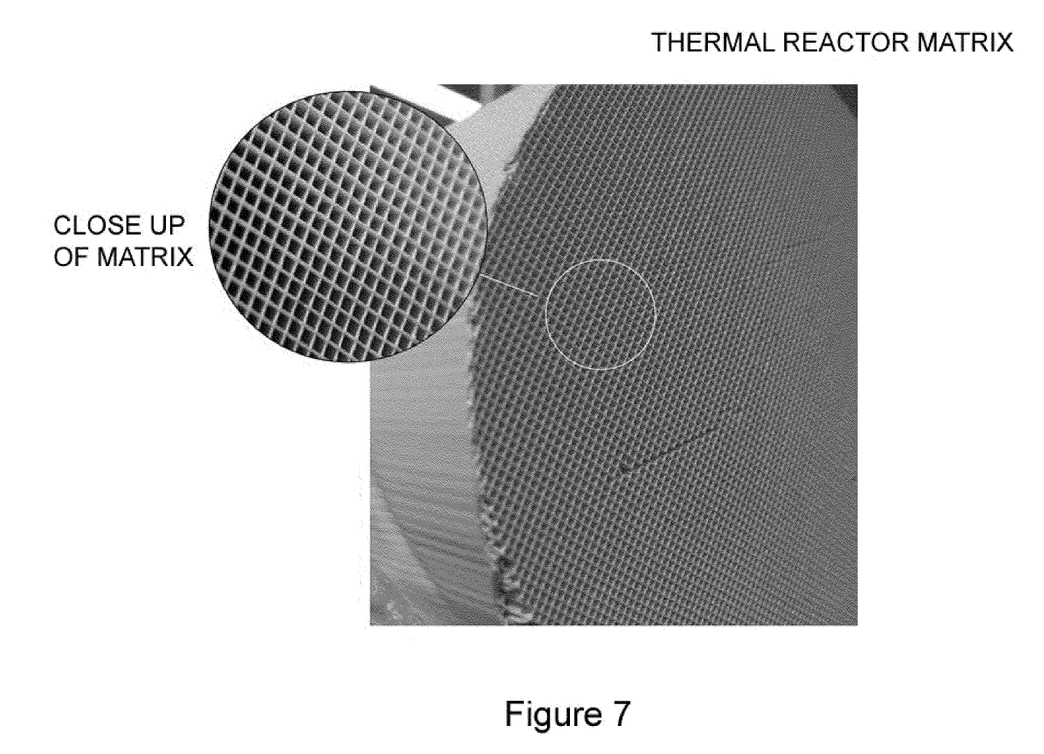

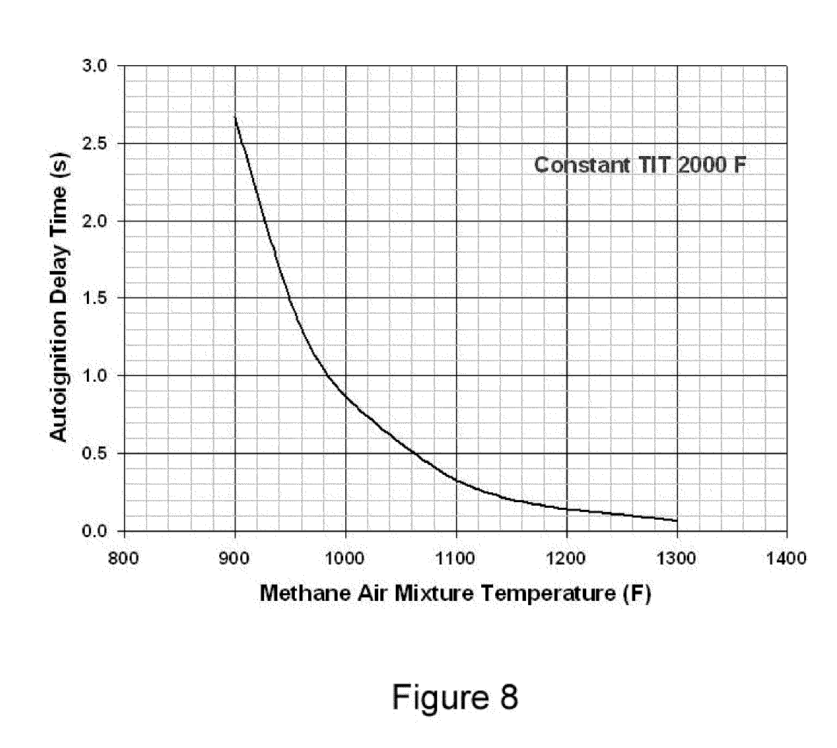

FIG. 8 illustrates auto-ignition delay times as a function of fuel-air mixture inlet temperature for methane in a thermal reactor. The reactor considered for this calculation is for a multi-spool intercooled, recuperated gas turbine engine (such as shown in FIGS. 6 and 7) with a fuel-air ratio of about 0.0148 for methane with an air-fuel flow rate of about 1.17 kg/s and a shaft power output at full power of about 375 kW. At full power, the inlet air-fuel mixture to the combustor is at about 780° K (˜950° F.) and the desired combustor output temperature is about 1,365° K (˜2,000° F.). The auto-ignition delay time at 780° K (˜950° F.) is about 1.5 seconds. The combustor inlet temperature is about 100° C. too low to reliably initiate combustion for the methane air mixture.

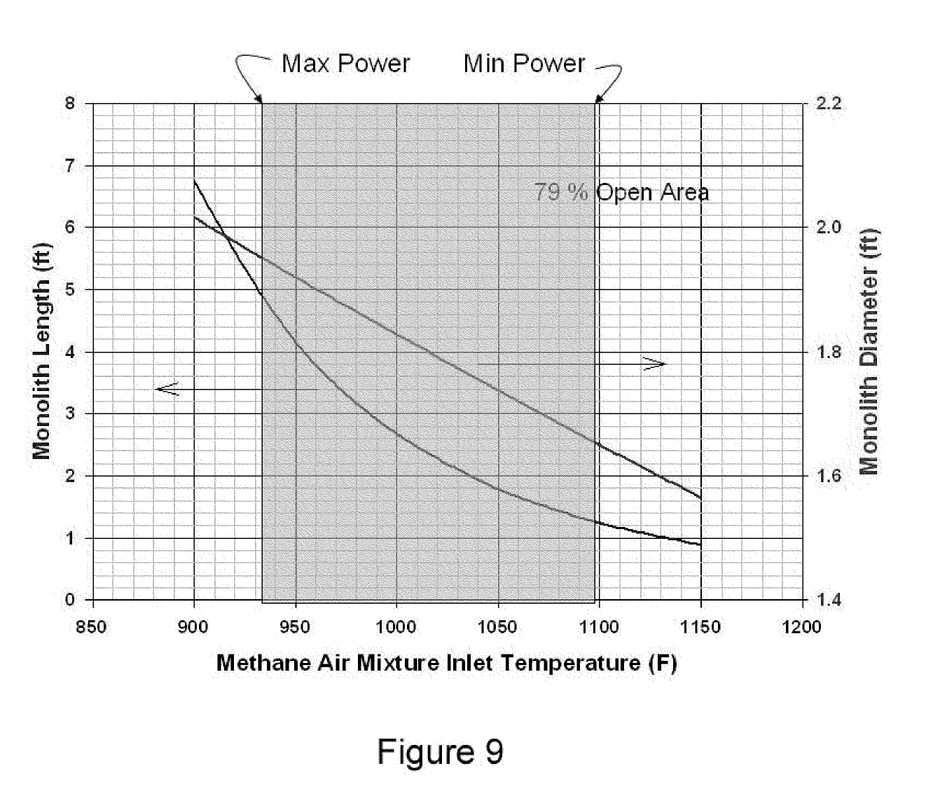

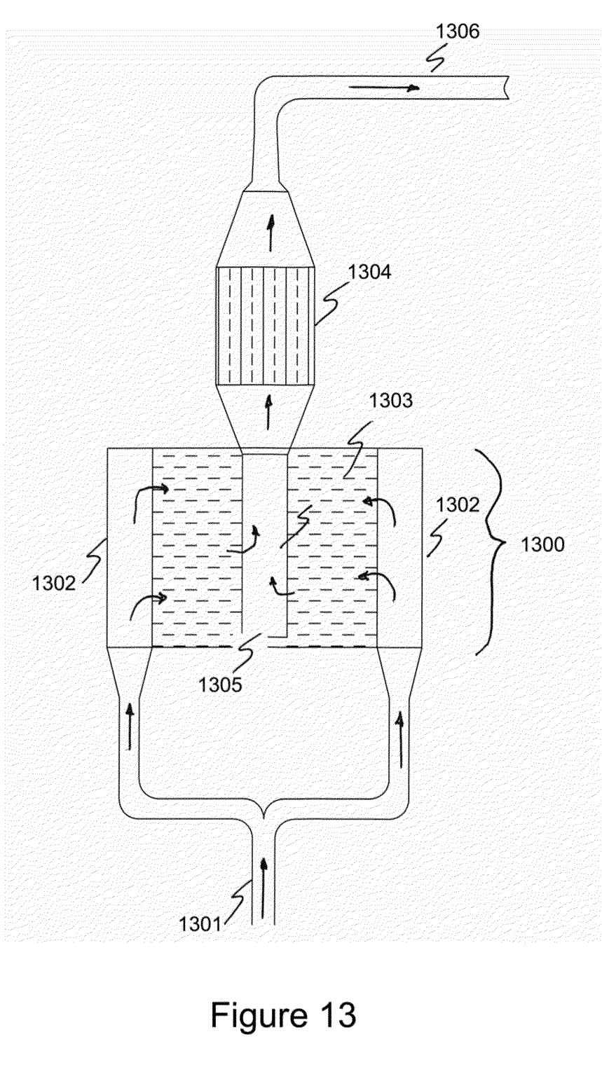

FIG. 9 illustrates estimated dimensions of a monolithic thermal reactor. For the engine conditions described for FIG. 13, the required length of a monolithic thermal reactor made from cordierite is in the range of about 5 to about 6 feet in length (about 1,500 mm to about 1,850 mm) at maximum power and the required diameter is in the range of about 1.95 feet (about 600 mm), also at maximum power. This applies to a design with an open cross-sectional flow area of about 80%.

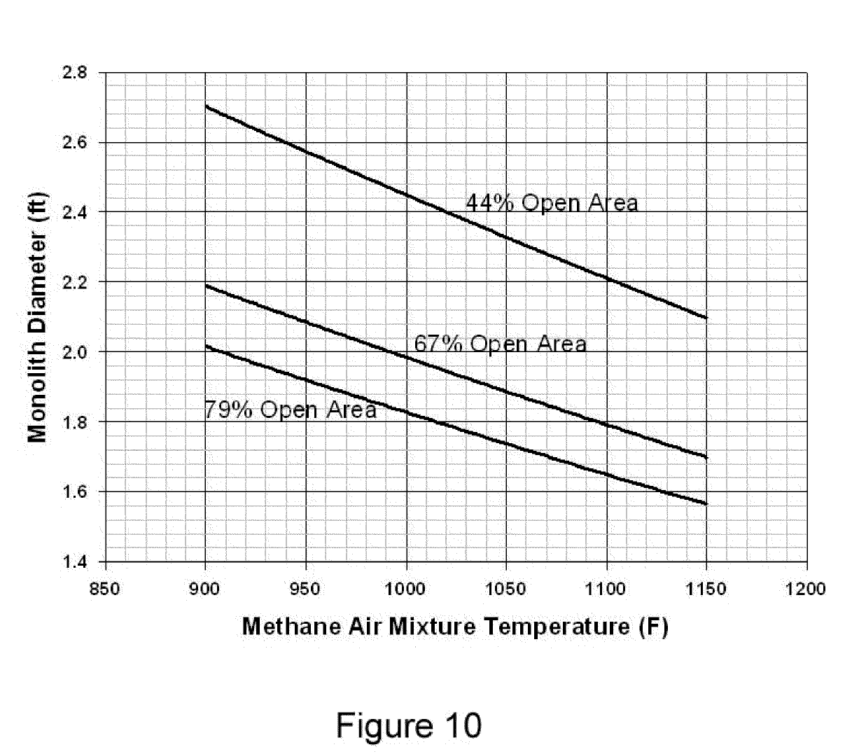

FIG. 10 illustrates computed effect of open area available in a monolithic thermal reactor. The open area is the ratio of channel cross-sectional area to overall thermal reactor cross-sectional area. The range of practical open areas ranges from about 40% to about 80%. As can be seen from FIG. 10, the greater the open area, the smaller the overall thermal reactor diameter to achieve the same performance.

In the calculation and tests described in FIGS. 8 through FIG. 10, the combustor inlet temperature is about 100 Centigrade degrees too low to reliably initiate combustion for the methane air mixture. The design intent was to employ the honeycomb to conduct heat upstream to effect the reaction rate. This has been proven to be ineffective for honeycomb modules under about 30-inches in diameter for the combination of an air-methane mixture and the matrix material cordierite.

### The Problem of the Thermal Reactor for Vehicle Applications

In the engine illustrated in FIG. 6, a metallic can-type combustor is installed substantially inside the recuperator. This configuration along with the relatively high overall pressure ratio of the two compressors (approximately 15:1), serve to keep the volume of these two components (recuperator and combustor) low and allows the overall engine to remain compact with a specific power in the range of about 0.65 to about 0.7 kW/kg and the power density in the range of about 220 to about 250 kW/cu m. For a 375 kW engine such as shown in FIG. 6, the combustor is about 0.4 meters long by about 0.16 meters in diameter. If the metallic combustor is replaced by a thermal reactor, then the length and diameter of the thermal reactor should be about the same as those of the metallic combustor to preserve the compact size of the engine.

For many fuels, such as diesel, a thermal reactor of the desired size can be successfully fabricated since the auto-ignition delay time of diesel fuels is relatively short and full reaction of the diesel fuel-air mixture can readily take place in a thermal reactor of reasonable diameter and length. However, methane or natural gas is a preferred fuel because, of all the hydrocarbon fuels, it emits the lowest amount of CO₂ per unit of energy delivered. The auto-ignition delay time of methane is relatively long as shown in FIG. 8 and full combustion will likely not take place in a thermal reactor of reasonable diameter or length. While a large thermal reactor installed outside the recuperator is practical for a stationary power plant, it is not practical for a vehicle engine as the overall size of the engine is important. A compact, high specific power gas turbine engine is about half the size and weight of its diesel counterpart so a compact thermal reactor is essential if this advantage is to be preserved while adding the advantages of even lower emissions and higher thermal efficiency.

Natural gas is an important fuel and its use eliminates many reliability issues associated with turbines. For example, combustion systems are the source of many turbine failures or premature overhauls.

As will now be discussed, the use of a heat pipe or bundle of heat pipes has the potential to move heat at the required high power from the combustion products exiting the thermal reactor to pre-heat the air or air-fuel mixture exiting the recuperator. This approach has the potential for overcoming the size limitation for a thermal reactor using a methane-air fuel-air mixture.

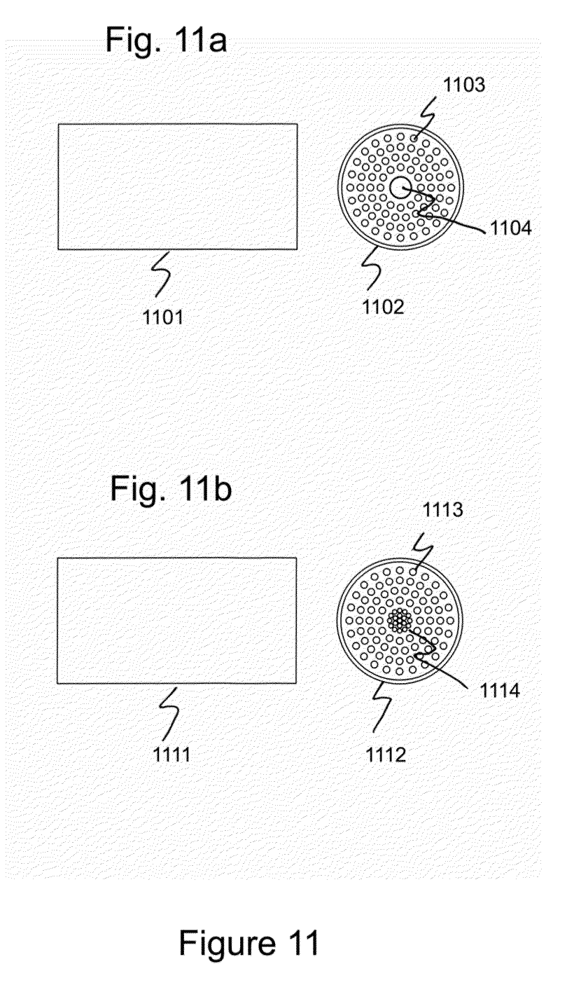

FIG. 11 illustrates a concept for reducing auto-ignition delay time for methane in a thermal reactor using a heat pipe or pipes. As discussed previously, the power required to pre-heat an air fuel mixture by about 100° K for a flow of about 1.2 kg/sec is estimated to be about 132 kW (m Cp dT where m=1.2 kg/s, Cp=1,100 J/kg-K and dT=100° K). One way to provide this power is to transport heat energy from the output of the combustor to the input side of the combustor via a heat pipe or bundle of heat pipes. Reasonably sized heat pipes using sodium or lithium as the working fluid can transport heat energy at the required level of power. For example, a 2-inch diameter (50.8 mm) heat pipe using sodium can transport about 100 to about 200 kW axially, so such heat pipes have the potential to move the required amount of heat from the output of the combustor to the input side of the combustor.

FIG. 11a illustrates a thermal reactor 1101 with a heat pipe 1104 located at the center of the reactor. Axial reactor flow tubes 1103 are also shown in the reactor containment vessel 1102. FIG. 11b illustrates a thermal reactor 1111 with a bundle of heat pipes 1114 located at the center of the reactor. Axial reactor flow tubes 1113 are also shown in the reactor containment vessel 1112. If combustor input temperature is about 880° K and combustor output temperature is about 1,370° K, then for an engine with a mass flow of about 1.2 kg/sec, the length of the thermal reactor will be about 370 mm, the diameter of the thermal reactor will be about 500 mm and the heat pipe will be about 55 mm in diameter.

In the above example, if a heat pipe were not used, then combustor input temperature would be about 780° K. If combustor output temperature is about 1,370° K, then for an engine with a mass flow of about 1.2 kg/sec, the length of the thermal reactor will be about 1,550 mm and the diameter of the thermal reactor will be about 600 mm.

In both the above examples, the thermal reactors would be capable of fully reacting the required input air-fuel mix where the fuel is natural gas.

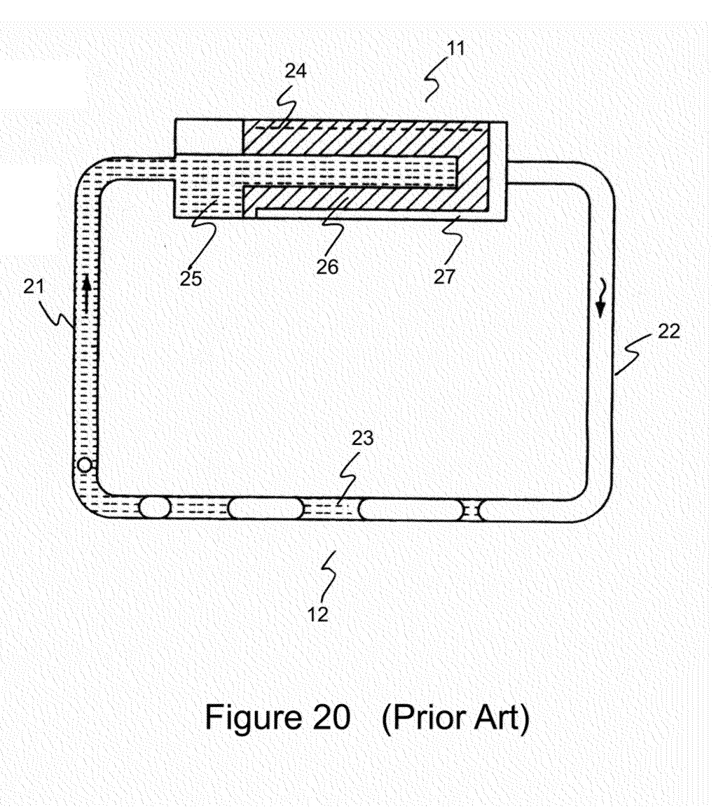

As can be appreciated, the heat pipes can be located outside the reactor vessel as long as heat input and output contact elements are located in the reactor inlet and outlet respectively. This configuration is shown below as a loop system in FIG. 20. The loop configuration is less preferable as it is not readily contained within the recuperator as would be desired for a compact recuperated engine design.

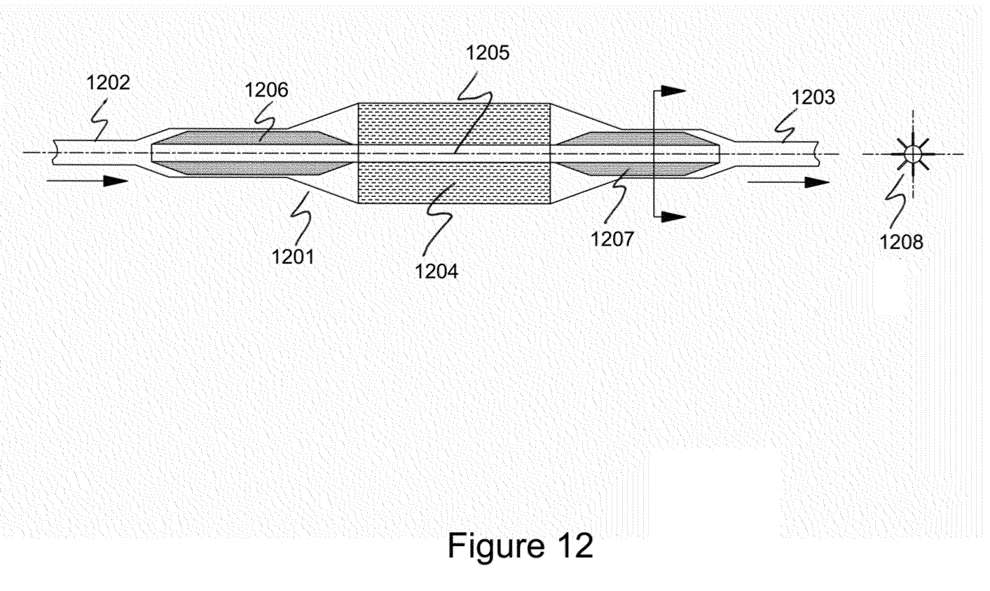

FIG. 12 further illustrates a concept for reducing auto-ignition delay time for methane in a thermal reactor using a heat pipe or pipes. While heat pipes of reasonable diameter can transport heat energy from the hot end to the cold end at high power, the difficulty can be getting heat into the hot end and out of the cold end. FIG. 12 illustrates a thermal reactor 1204 with a heat pipe 1205 located along the axis of the thermal reactor. Air-fuel flow enters via duct 1202, flows past heat pipe fins 1206, through reactor 1204 and the products of combustion exit past heat pipe fins 1207 and out duct 1203. The flow cross-sectional area of duct 1202 (which typically brings the flow from the cold side of a recuperator) is about the same as the cross-sectional area of duct with fins 1206. Similarly, the flow cross-sectional area of duct 1203 (which typically delivers the flow to a high pressure turbine) is about the same as the cross-sectional area of duct with fins 1207. The fins 1206 in the cold section are typically longer than the fins 1207 in the hot section. The end view of fins 1207 is shown by 1208.

The purpose of fins 1206 is to present sufficient area to the incoming flow so that heat energy can be efficiently transported from the condenser end of the heat pipe to the flow. The fins 1206 may be solid by preferably hollowed out to facilitate high heat flux.

The purpose of fins 1207 is to present sufficient area to the outgoing flow so that heat energy can be efficiently transported from the flow to the evaporator end of the heat pipe. The fins 1207 may be solid by preferably hollowed out to facilitate high heat transfer.

The example engine described previously is gas turbine engine with a fuel-air ratio of about 0.0148 for methane with an air-fuel flow rate of about 1.17 kg/s and a shaft power output at full power of about 375 kW. At full power, the inlet air-fuel mixture to the combustor is at about 780° K (˜950° F.) and the desired combustor output temperature is about 1,365° K (˜2,000° F.). For this level of combustor output temperature, the heat pipe casing and fins may be fabricated form high temperature metals such as, for example, Hastealloy, Kanthal or Inconel. The casing and fins in the hot (evaporator) section may be coated with tungsten, tantalum or a tungsten and tantalum coating for improving wear and reducing the temperature of the casing. Such coating can be achieved using vapor deposition or any of a number of cold welding techniques used for bonding dissimilar materials.

The working fluid may be sodium or lithium. The wick may be a stainless steel mesh or a niobium mesh, for example.

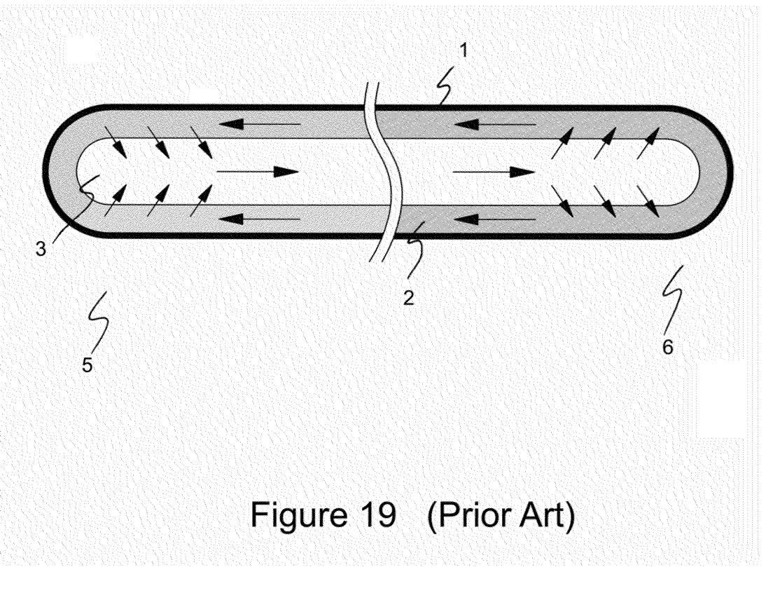

The heat pipe shown in FIG. 12 is a wicked heat pipe configuration (see FIG. 19). It is also possible to use a loop type heat pipe system (see FIG. 20) if a wicked heat pipe cannot be designed to transport the condensed working fluid back via the wick.

FIG. 13 illustrates a compact thermal reactor located outside a counter flow recuperator. In this figure, a thermal reactor 1304 that is too large to fit within a recuperator 1300 is illustrated. In FIG. 13, air or an air-fuel mixture enters the cold side of recuperator 1300 from the output of a compressor via duct 1301. The fluid enters the recuperator manifolds 1302 and flows through the recuperator matrix 1303, absorbing heat energy from the hot side flow (not shown). The heated fluid then exits the recuperator via center manifold 1305 and enters thermal reactor 1304 where the fuel/air mixture is fully reacted. The combustion products exit the thermal reactor and flow to a turbine via duct 1306.

In the case of a fuel such as natural gas, the fuel can be introduced with air at the inlet to the gas turbine engine. In the case of a liquid fuel, it can be pressurized and introduced as a mist or small droplets by a fuel injection system between the output of the recuperator and input to the thermal reactor.

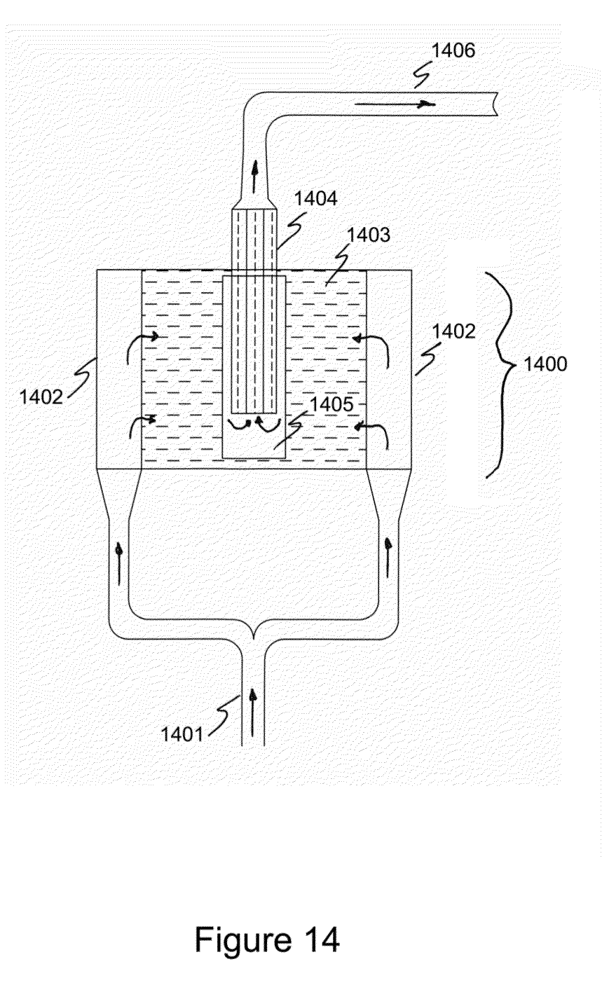

FIG. 14 illustrates a compact thermal reactor located partially inside a counter flow recuperator in Z-type configuration. In this figure, a thermal reactor 1404 is sufficiently compact that it may fit partially or wholly within the center manifold 1405 of recuperator 1400. In FIG. 14, air or an air-fuel mixture enters the cold side of recuperator 1400 from the output of a compressor via duct 1401. The fluid enters the recuperator manifolds 1402 and flows through the recuperator matrix 1403, absorbing heat energy from the hot side flow (not shown). The heated fluid then enters thermal reactor 1404 where the fuel/air mixture is fully reacted. The combustion products exit the thermal reactor and flow to a turbine via duct 1406.

In the case of a fuel such as natural gas, the fuel can be introduced with air at the inlet to the gas turbine engine. In the case of a liquid fuel, it can be pressurized and introduced as a mist or small droplets by a fuel injection system possibly located at the bottom of recuperator 1400.

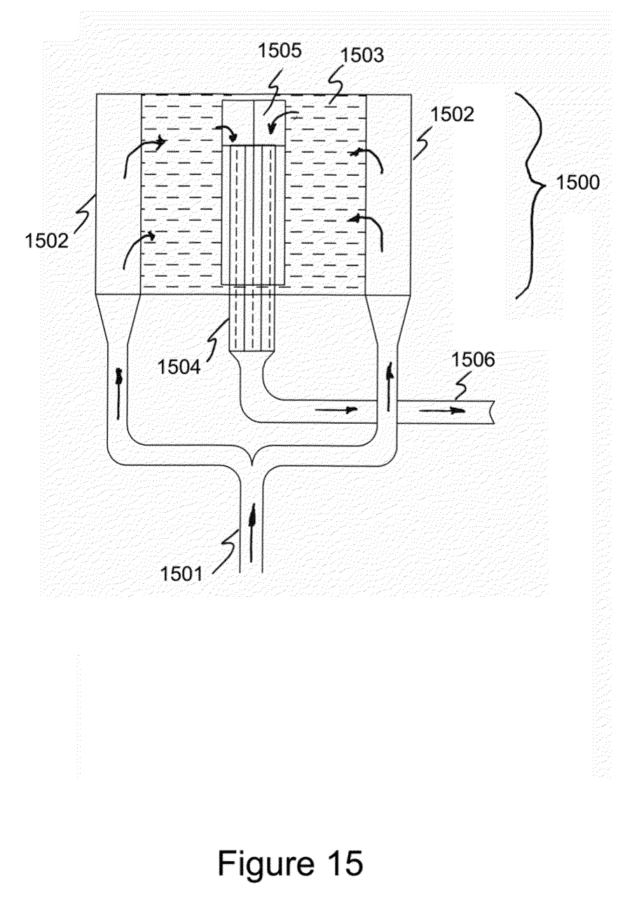

FIG. 15 illustrates a compact thermal reactor located partially inside a counter flow recuperator in C-type configuration. In this figure, a thermal reactor 1504 is sufficiently compact that it may fit partially or wholly within the center manifold 1505 of recuperator 1500. In FIG. 15, air or an air-fuel mixture enters the cold side of recuperator 1500 from the output of a compressor via duct 1501. The fluid enters the recuperator manifolds 1502 and flows through the recuperator matrix 1503, absorbing heat energy from the hot side flow (not shown). The heated fluid then enters thermal reactor 1504 where the fuel/air mixture is fully reacted. The combustion products exit the thermal reactor and flow to a turbine via duct 1506.

In the case of a fuel such as natural gas, the fuel can be introduced with air at the inlet to the gas turbine engine. In the case of a liquid fuel, it can be pressurized and introduced as a mist or small droplets by a fuel injection system possibly located at the top of recuperator 1500.

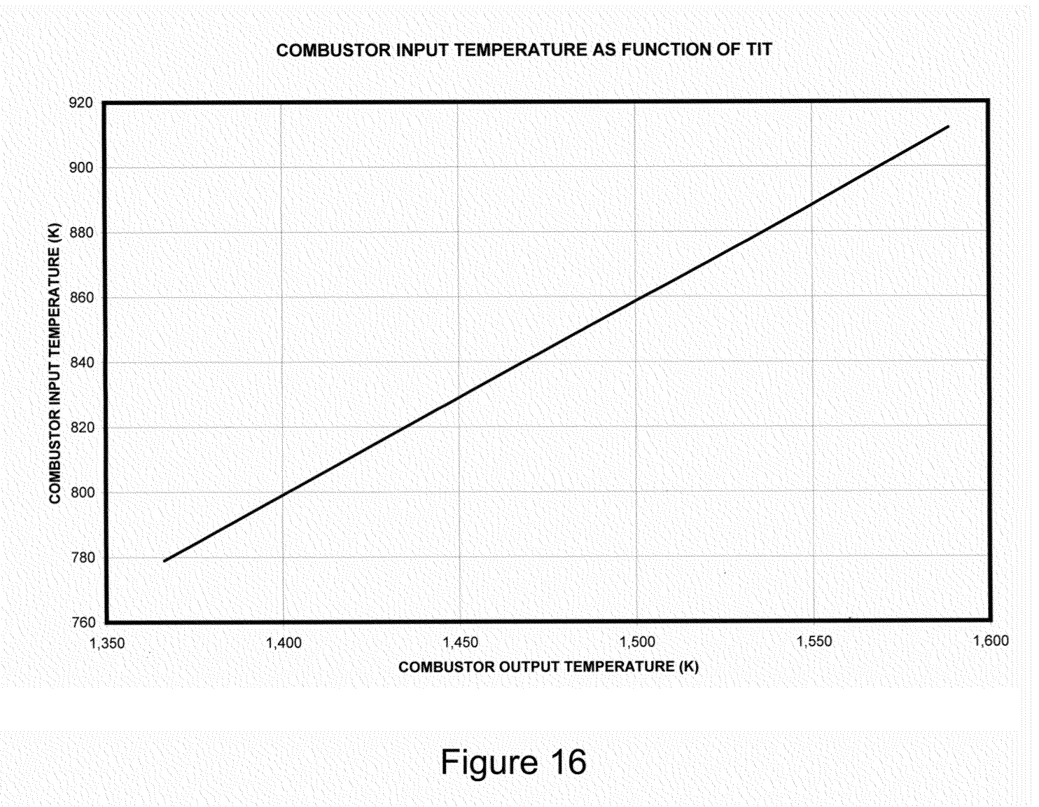

FIG. 16 shows thermal reactor input temperature as a function of thermal reactor output temperature. If thermal reactor output temperature is increased from about 1,370° K to about 1,535° K, input temperature to the thermal reactor increases from about 780° K to about 880° K. Thus it is possible to create conditions for sufficiently rapid reaction of CH₄ by increasing combustion output temperature by about 170° K. This is only possible with a recuperated engine such as shown in FIG. 6 since an increase in combustion output temperature leads to a higher temperature difference across the recuperator and therefore a transfer of enough additional heat energy to cause the required increase in thermal reactor input temperature.

Of course, increasing combustion output temperature necessitates a redesign of components such as the recuperator, the high pressure turbine and probably the low pressure turbines so that they can operate at somewhat higher temperatures.

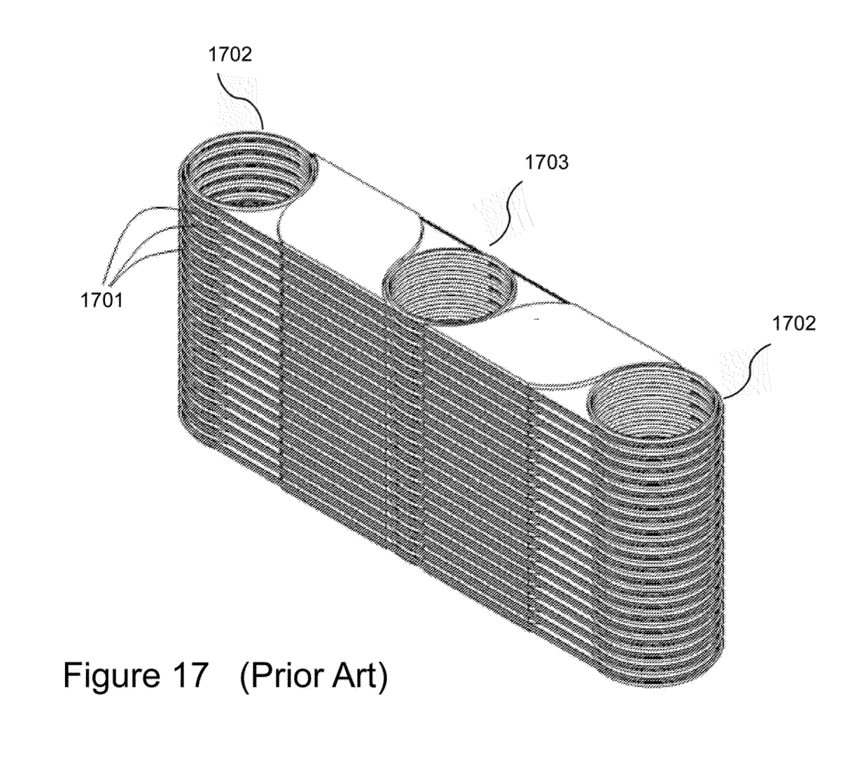

FIG. 17 is an isometric schematic view of a prior art recuperator. This heat exchanger was disclosed in U.S. Pat. No. 8,215,378 entitled “Heat Exchanger with Pressure and Thermal Strain Management”. This design is a three-manifold, dual-matrix counter-flow plate-fin heat exchanger, whose design allows free growth of a hot center manifold supported by tensile structures at cold ends. This heat exchange device includes a plurality of heat exchange cells in a stacked configuration 1701 arranged around two outer manifolds 1702 and an intermediate manifold 1703 which, in this example, is shown centered between the two outside manifolds 1702. Each of the manifolds has a closed end and an open end opposite the closed end. The heat exchange core may be comprised of any number of cells, for example, ranging from two to several hundred or more.

In this design, the cold side gas enters the bottom of the outside manifolds 1702 and flows inward to the center manifold 1703. The hot side gas flows into one side of the heat exchanger and is turned to flow counter to the cold side gas and is then turned again to flow outward from the opposite side of the heat exchanger.

It is possible to position a combustor in the center manifold to conserve space in the combustor-recuperator assembly. The technique of embedding the combustor inside a recuperator is not new. As can be seen, the combustor will be in close proximity to the recuperator and therefore protecting the recuperator from the radiated heat from the combustor will be an important design consideration, especially if it is desired to increase the pressure and temperature of the combustion process so as to increase overall engine thermal efficiency. When a combustor is inserted into an appropriate manifold of a recuperator, this manifold is sometimes referred to as the recuperator core.

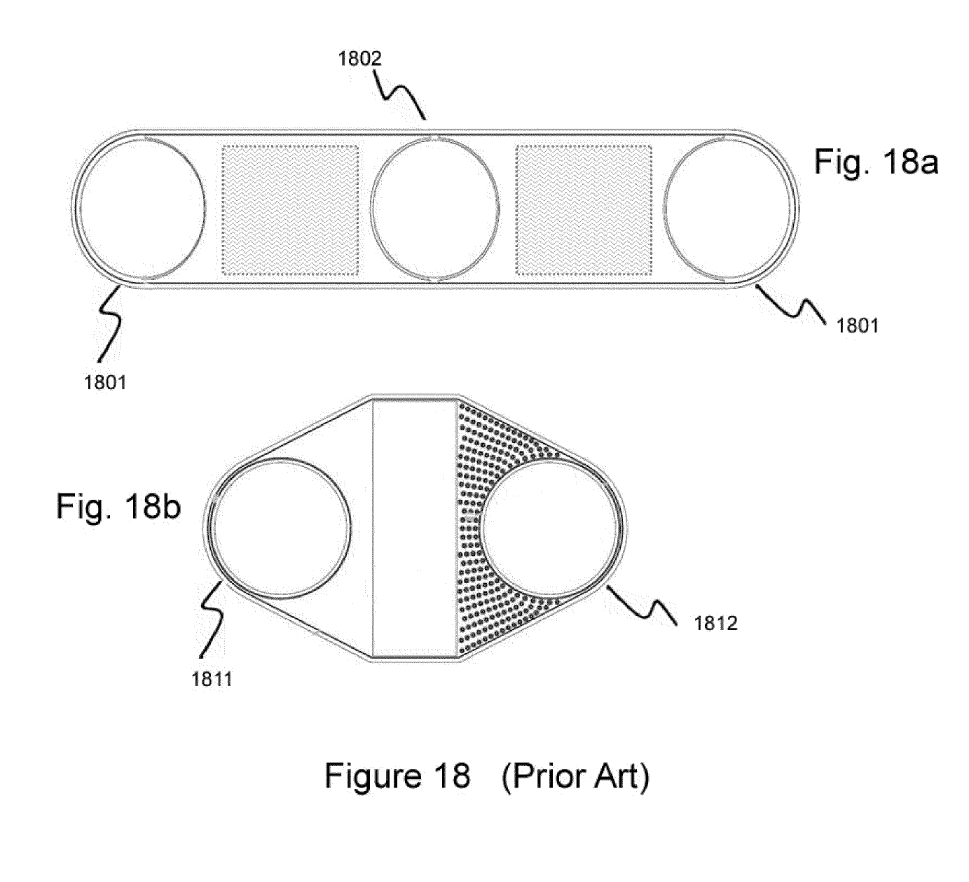

FIG. 18 is a schematic view of prior art recuperators. FIG. 18a illustrates the heat exchanger of FIG. 17 in which the cold side gas enters the bottom of the outside manifolds 1801 and flows inward to the center manifold 1802. FIG. 18b illustrates a heat exchanger with two manifolds 1811 and 1812. This design is disclosed in U.S. Pat. No. 8,371,365 entitled “Heat Exchange Device and Method for Manufacture”. Either heat exchanger configuration can be adapted as a recuperator for a gas turbine engine, and both can be adapted to allow the main combustor to be embedded in the manifold which has cold side air flowing into the combustor along the length of the combustor.

### Heat Pipes

FIG. 19 illustrates a wick type heat pipe. In this form of heat pipe, the working fluid evaporates in the wick 2 at the high temperature end 5 as heat is absorbed through the casing walls 1 at the high temperature end 5. The working fluid, now a vapor, travels down the vapor cavity 3 to the low temperature end 6 where it condenses and the heat liberated passes through the casing walls 1 at the low temperature end 6. The condensed working fluid is absorbed into the wick 2 then returns to the high temperature end 5 via the wick system 2 that moves the working fluid along by capillary action.

A typical heat pipe consists of a sealed pipe or tube made of a material with high thermal conductivity such as copper or aluminum at both hot and cold ends. A vacuum pump is used to remove all air from the empty heat pipe, and then the pipe is filled with a fraction of a percent by volume of working fluid chosen to match the operating temperature. Due to the partial vacuum that is near or below the vapor pressure of the fluid, some of the fluid will be in the liquid phase and some will be in the gaseous phase. The use of a vacuum eliminates the need for the working gas to diffuse through any other gas and so the bulk transfer of the vapor to the cold end of the heat pipe is at the speed of the moving molecules. In this sense, the only practical limit to the rate of heat transfer is the speed with which the gas can be condensed to a liquid at the cold end. Alternately, when making heat pipes, there is no need to create a vacuum in the pipe. The working fluid is boiled in the heat pipe until the resulting vapor has purged the non condensing gases from the pipe and then the end is sealed.

Inside the pipe's walls, a wick structure exerts a capillary pressure on the liquid phase of the working fluid. This is typically a sintered metal powder or a series of grooves parallel to the pipe axis, but it may be any material capable of exerting capillary pressure on the condensed liquid to wick it back to the heated end. The heat pipe may not need a wick structure if gravity or some other source of acceleration is sufficient to overcome surface tension and cause the condensed liquid to flow back to the heated end.

Heat pipes contain no mechanical moving parts and typically require little if any maintenance. The advantage of heat pipes over many other heat-transport mechanisms is their great efficiency in transferring heat. They are a fundamentally better heat conductor than an equivalent cross-section of solid copper. Some heat pipes have demonstrated a heat flux of more than 230 MW/m².

FIG. 20 illustrates a loop type heat pipe system. A typical loop type system is comprised of a evaporator 24, a wick 26, a vapor removal channel 27, a compensation chamber 25 and a condenser 23. Heat energy is input to the working fluid to the system from outside region 11 and the evaporated working fluid flows along vapor conduit 22 to condenser 23 where it begins to condense to a liquid, giving up its heat energy to region 12. The condensed working fluid flows along liquid conduit 21 back to the evaporator 24. A loop heat pipe is a two-phase heat transfer device that uses capillary action to remove heat from a source and passively move it to a condenser or radiator. Loop heat pipes are similar to wick type heat pipes but have the advantage of being able to provide reliable operation over long distance and the ability to operate against gravity. They can transport a large heat load over a long distance with a small temperature difference.

The main reason for the effectiveness of heat pipes is the evaporation and condensation of the working fluid. The heat of vaporization greatly exceeds the sensible heat capacity. Using water as an example, the energy needed to evaporate one gram of water is 540 times the amount of energy needed to raise the temperature of that same one gram of water by 1° K Almost all of that energy is rapidly transferred to the “cold” end when the fluid condenses there, making a very effective heat transfer system with no moving parts.

The disclosure has been described with reference to the preferred embodiments. Modifications and alterations will occur to others upon a reading and understanding of the preceding detailed description. It is intended that the disclosure be construed as including all such modifications and alterations insofar as they come within the scope of the appended claims or the equivalents thereof.

A number of variations and modifications of the disclosures can be used. As will be appreciated, it would be possible to provide for some features of the disclosures without providing others.

The present disclosure, in various embodiments, includes components, methods, processes, systems and/or apparatus substantially as depicted and described herein, including various embodiments, sub-combinations, and subsets thereof. Those of skill in the art will understand how to make and use the present disclosure after understanding the present disclosure. The present disclosure, in various embodiments, includes providing devices and processes in the absence of items not depicted and/or described herein or in various embodiments hereof, including in the absence of such items as may have been used in previous devices or processes, for example for improving performance, achieving ease and\or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the disclosure.

Moreover though the description of the disclosure has included description of one or more embodiments and certain variations and modifications, other variations and modifications are within the scope of the disclosure, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method, comprising:
receiving, by a gas turbine engine, a fuel mixture of air and a fuel dispersed in the air;
contacting the fuel mixture with one or more heat pipes, the one or more heat pipes transferring thermal energy from a combustor reaction products to form a heated fuel mixture; and
combusting the heated fuel mixture to form the combustor reaction products.

2. The method of claim 1, wherein the combustor is a thermal oxidizer, wherein the fuel dispersed in the air comprises methane, wherein the fuel mixture is preheated by at least about 100 to about 150° K, and wherein the combustor is positioned at least partially within an enclosure of a recuperator.

3. The method of claim 1, wherein the one or more heat pipes comprises a first thermally conductive solid surface to contact a liquid-phase heat exchange medium with the combustor reaction products to vaporize the liquid-phase heat exchange medium into a gas-phase heat exchange medium, a conduit to transport the gas-phase heat exchange medium, and a second thermally conductive solid surface to contact the gas-phase heat exchange medium with the one or more of the air, the fuel, and the fuel mixture to form the heated fuel mixture and return the heat exchange medium to the liquid phase for return to the first thermally conductive solid surface.

4. The method of claim 3, wherein the first and second thermally conductive solid surfaces each comprise one or more fins.

5. The method of claim 4, wherein liquid-phase heat exchange medium returns to the first thermally conductive solid surface by at least one of capillary action along a wick and gravity action, wherein the first and second thermally conductive solid surfaces comprise one or more of copper and aluminum, and wherein the liquid-phase heat exchange medium is one or more of water, ethanol, acetone, sodium, lithium, and mercury.

6. A method of claim 1, wherein the combustor is one or more of a can-type combustor, an annular combustor, a cannular combustor, and a metallic combustor, wherein the gas turbine engine comprises a plurality of turbo-compressor spools, a recuperator positioned upstream of the combustor, and a free power turbine operated by the combustor reaction products, and wherein the recuperator transfers a second portion of the thermal energy in the combustor reaction products to the air and thereafter the one or more heat pipes transfers a first portion of the thermal energy in the combustor reaction products to the one or more of the air, the fuel, and the fuel mixture.

7. The method of claim 1, wherein the one or more heat pipes are at least partially contained in the combustor.

8. The method of claim 1, wherein the combustor is positioned at least partly in one of at least two manifolds of the recuperator, wherein a first portion of the air enters an input end of the combustor, and wherein a central portion of the combustor comprises plural dilution holes to enable a second portion of air to enter the combustor from the recuperator.

9. The method of claim 1, wherein the one or more heat pipes are configured as one or more wick-type heat pipes.

10. The method of claim 1, wherein the one or more heat pipes are configured as one or more loop-type heat pipes.

11. A gas turbine engine, comprising:
at least first and second turbo-compressor spools, each of the at least first and second turbo-compressor spools comprising a compressor in mechanical communication with a corresponding turbine;
a recuperator operable to transfer a second portion of thermal energy of an output gas of a power turbine to a compressed gas produced by the compressor of the at least first and second turbo-compressor spools, thereby providing a heated fuel and air mixture;
a combustor operable to combust a further heated fuel and air mixture to form combustor reaction products; and
one or more heat pipes transferring a first portion of thermal energy from the combustor reaction products to the heated fuel and air mixture to form the further heated fuel and air mixture.

12. The gas turbine engine of claim 11, wherein the combustor is a thermal oxidizer, wherein the fuel dispersed in the compressed gas comprises methane, wherein the fuel mixture is preheated by at least about 100 to about 150° K, and wherein the combustor is positioned at least partially within an enclosure of the recuperator.

13. The gas turbine engine of claim 11, wherein the one or more heat pipes comprises a first thermally conductive solid surface to contact a liquid-phase heat exchange medium with the output gas to vaporize the liquid-phase heat exchange medium into a gas-phase heat exchange medium, a conduit to transport the gas-phase heat exchange medium, and a second thermally conductive solid surface to contact the gas-phase heat exchange medium with the one or more of the compressed gas, a fuel, and a fuel mixture to form the further heated fuel mixture and return the heat exchange medium to the liquid phase for return to the first thermally conductive solid surface.

14. The gas turbine engine of claim 13, wherein the first and second thermally conductive solid surfaces each comprise one or more fins.

15. The gas turbine engine of claim 14, wherein liquid-phase heat exchange medium returns to the first thermally conductive solid surface by at least one of capillary action along a wick and gravity action, wherein the first and second thermally conductive solid surfaces comprise one or more of copper and aluminum, and wherein the liquid-phase heat exchange medium is one or more of water, ethanol, acetone, sodium, lithium, and mercury.

16. A gas turbine engine of claim 11, wherein the combustor is one or more of a can-type combustor, an annular combustor, a cannular combustor, and a metallic combustor, wherein the gas turbine engine comprises a plurality of turbo-compressor spools, a recuperator positioned upstream of the combustor, and a free power turbine operated by the waste gas, and wherein the recuperator transfers a second portion of the thermal energy in the waste gas to the air and thereafter the one or more heat pipes transfers a first portion of the thermal energy in the waste gas to the one or more of the compressed gas, a fuel, and a fuel mixture.

17. The gas turbine engine of claim 11, wherein the one or more heat pipes are at least partially contained in the combustor.

18. The gas turbine engine of claim 1, wherein the combustor is positioned at least partly in a center manifold of the recuperator, wherein a first portion of the air enters an input of the combustor, and wherein a central portion of the combustor comprises plural dilution holes to enable a second portion of air to enter the combustor from the recuperator.

19. The gas turbine engine of claim 11, wherein the one or more heat pipes are configured as one or more wick-type heat pipes.

20. The gas turbine engine of claim 11, wherein the one or more heat pipes are configured as one or more loop-type heat pipes.
